(19) United States
(12) Patent Application Publication
(10) Pub. No.: US 2020/0303748 A1
(43) Pub. Date: Sep. 24, 2020

(54) NANOMANUFACTURING OF METALLIC GLASSES FOR ENERGY CONVERSION AND STORAGE

(71) Applicant: University of North Texas, Denton, TX (US)

(72) Inventors: Vahid Hasannaeimi, Denton, TX (US); Sundeep Mukherjee, Denton, TX (US)

(21) Appl. No.: 16/607,260

(22) PCT Filed: Apr. 23, 2018
(86) PCT No.: PCT/US2018/028840

§ 371 Date: Oct. 22, 2019

Related U.S. Application Data
(60) Provisional application No. 62/489,157, filed on Apr. 24, 2017.

(51) Int. Cl. H01M 4/88; H01M 4/90; H01M 4/92; C25D 21/12; C25D 1/00

(52) U.S. Cl. CPC H01M 4/8853; H01M 4/9058; C25D 1/006; C25D 21/12; H01M 4/921

(57) ABSTRACT

The present application relates to systems and methods for forming catalysts for use in fuel cells, other energy storage/generation devices, and other applications where catalysts may be used. In embodiments, a catalyst comprising one or more metallic glass structures may be formed by disposing a porous mold in a plating bath comprising one or more dissolved metal salts. An electrodeposition process may be initiated by applying current to the plating bath, where the electrodeposition process forms the one or more metallic glass structures within pores of the porous mold. One or more sensors may be used to monitor one or more properties of the electrodeposition process during the application of the current to the plating bath, and the one or more properties of the electrode-position process may be controlled, based on the monitoring of the one or more parameters, to adjust one or more characteristics of the metallic glass structures.

### CROSS-REFERENCE TO RELATED APPLICATIONS

The present application claims priority to U.S. Provisional Patent Application No. 62/489,157, filed Apr. 24, 2017 and entitled, “NANOMANUFACTURING OF METALLIC GLASSES FOR ENERGY CONVERSION AND STORAGE,” the disclosure of which is incorporated here by reference in its entirety.

### TECHNICAL FIELD

The present application relates to formation of catalysts, and more particularly to embodiments of improved methods and systems for forming catalysts comprising metallic glass structures via an electrodeposition process.

### BACKGROUND

Fuel cells and other energy storage devices utilize catalysts to promote reactions that generate hydrogen ions and electrons, which may be utilized by the fuel cell to produce electric power. Often, catalysts for fuel cell and other energy storage device are formed from pure precious metals, such as platinum (Pt), palladium (Pd), and gold (Au). However, catalysts formed from these metals are expensive to manufacture due to the high cost associated with the aforementioned precious metals. Further, these catalysts may suffer from drawbacks associated with durability and/or performance. For example, the durability and/or performance of catalysts formed from these pure precious metals may be negatively impacted by poisoning (e.g., partial or total deactivation of the catalyst due to exposure to certain chemicals and/or chemical compounds).

### SUMMARY

The present application relates to systems and methods for forming catalysts for use in fuel cells, other energy storage/generation devices, and other applications where catalysts may be used. In embodiments, a catalyst comprising one or more metallic glass structures may be formed by disposing a porous mold in a plating bath comprising one or more dissolved metal salts. An electrodeposition process may be initiated by applying current to an anode disposed the plating bath, where the electrodeposition process forms the one or more metallic glass structures within pores of the porous mold. One or more sensors may be used to monitor one or more properties of the electrodeposition process during the application of the current to the anode, and the one or more properties of the electrodeposition process may be controlled, based on the monitoring of the one or more parameters, to adjust one or more characteristics of the metallic glass structures, thus providing fine-grained control over the formation of catalysts and allowing the catalysts to be optimized to achieve improved catalyst performance, reliability, and durability, as described in more detail below.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates aspects of a cross section of a porous mold suitable for forming a catalyst in accordance with embodiments of the present disclosure;

FIG. 2 illustrates a top view of a porous mold suitable for forming a catalyst in accordance with embodiments of the present disclosure;

FIG. 3 illustrates a system for forming a catalyst comprising one or more metallic glass structures in accordance with embodiments of the present disclosure;

FIG. 4 illustrates aspects of forming a catalyst comprising one or more metallic glass structures formed in accordance with embodiments of the present disclosure;

FIG. 5 illustrates aspects of a catalyst comprising one or more metallic glass structures formed in accordance with embodiments of the present disclosure;

FIG. 6 illustrates aspects of a catalyst comprising one or more metallic glass structures formed in accordance with embodiments of the present disclosure; and

FIG. 7 is a flow diagram illustrating an exemplary method for forming a catalyst comprising one or more metallic glass structures in accordance with embodiments of the present disclosure.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

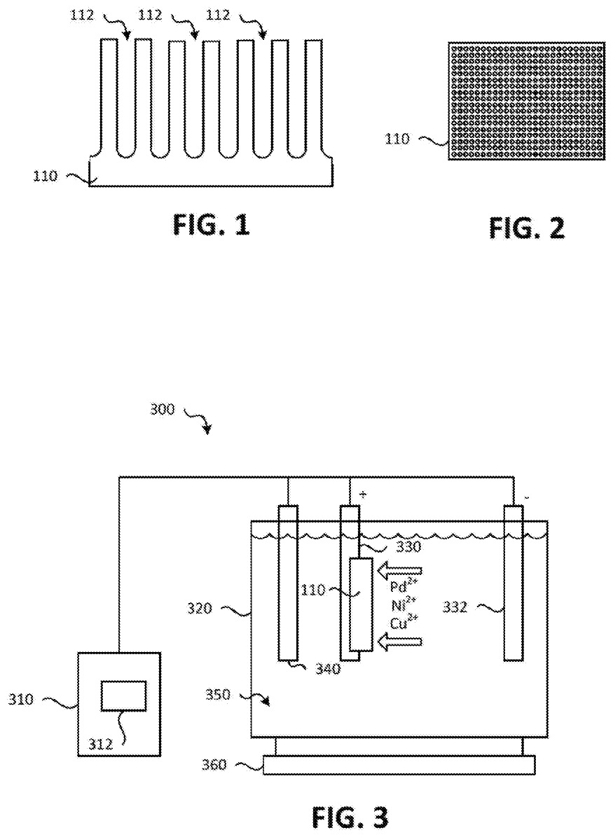

Referring to FIG. 1, a diagram illustrating aspects of a porous mold suitable for forming a catalyst in accordance with embodiments of the present disclosure is shown. In embodiments, a porous mold comprising a plurality of pores may be utilized to form a catalyst that includes one or more metallic glass structures. For example, in FIG. 1, a porous mold 110 is shown and includes a plurality of pores 112. In embodiments, the porous mold 110 may comprise an anodized aluminum oxide (AAO) nano-mold. In embodiments, the plurality of pores 112 may have a width that is at least one (1) nanometer (nm). In some embodiments, the width may be between one (1) nm and two (2) nm. In still other embodiments, the width may be between one (1) nm and twenty (20) nm. In still further embodiments, the width may be as small as one (1) nm and a few hundred nm (e.g., one hundred (100) nm to three hundred (300) nm). In embodiments, the plurality of pores 112 may have uniform or varying geometries. For example, in one aspect, the plurality of pores 112 may have a circular or generally circular geometry, and the width of the pores may correspond to a diameter of the circular or generally circular geometry. In some embodiments, the plurality of pores may have other geometries, such as branch-shaped geometry, an arc-shaped geometry, a tree-shaped geometry, and the like. FIG. 2 illustrates a top view of the porous mold 110 of FIG. 1. It is noted that the particular width of any individual pore may vary relative to other pores, and that each pore is not required to have exactly the same width and/or geometry. Further, it is noted that in some embodiments, an interpore distance (e.g., a distance between adjacent pores) may be uniform across the porous mold 110, as shown in FIG. 2, while in other embodiments, the interpore distance may vary from one pair of pores to another.

Referring to FIG. 3, a diagram illustrating a system for forming a catalyst comprising one or more metallic glass structures in accordance with embodiments of the present disclosure is shown as system 300. As shown in FIG. 3, the system 300 includes a controller 310, a tank 320, a cathode 330, an anode 332, one or more sensors 340, a plating bath 350, and a mixer 360. The plating bath 350 may include an electrolyte or solution that includes one or more dissolved metal salts, and may be disposed in the tank 320. In embodiments, the one or more dissolved metal salts of the plating bath may include palladium-based salts, platinum-based salts, gold-based salts, nickel-based salts, copper-based salts, or a combination thereof. The system 300 may also include a power source 312. It is noted that although the power source is shown as being incorporated into the controller 310, in some embodiments, the power source 312 may be external to, and communicatively coupled to the controller 310, such that the controller 310 maintains control over the current applied to the anode 332. Application of the current to the anode 332 under the control of the controller 310 may promote formation of the one or more metallic glass structures of the catalyst, as described in more detail below.

In embodiments, the one or more sensors 340 may include temperature sensors, pressure sensors, voltage sensors, a reference electrode, a saturated calomel (SCE), electrochemical sensors, other sensors, or a combination thereof. The one or more sensors 340 may be configured to monitor one or more properties of an electrodeposition process during the application of the current to anode 332 disposed in the plating bath 350. In embodiments, the one or more properties of the electrodeposition process may include a temperature of the plating bath 350, a pressure within the tank 320, a concentration of the one or more dissolved metal salts, a characteristic of the current applied to the anode 332, other properties, or a combination thereof.

During operation of the system 300, the porous mold 110 may be disposed in the plating bath 350. In embodiments, the porous mold 110 may be disposed within the plating bath 350 proximate to the cathode 330. In an embodiment, the anode 332 may comprise one or more metals, and, as current is applied to the anode 332, the metals of the anode may oxidize and dissolve into the plating bath to form the one or more metallic salts. In other embodiments, the anode 332 may be a non-consumable anode, such as lead or carbon, and the metallic salts may be provided to the plating bath from an external source (e.g., the plating bath may be prepared in advance of the electrodeposition process or the ions of the metals may be added to the plating bath to form the metallic salts). During the electrodeposition process, one or more metallic glass structures may be formed within pores of the porous mold 110, which is disposed in the plating bath proximate to the cathode 330. For example, the metallic salts may be reduced at the cathode 330, resulting in deposition of the metal within the pores of the porous mold 110.

The controller 310 may be configured to control the one or more properties of the electrodeposition process based on the monitoring by the one or more sensors 340 to adjust one or more characteristics of the metallic glass structures formed within the pores of the porous mold 110. In embodiments, the controller 310 may include a potentiostat and/or a galvanostat. In embodiments, adjusting the one or more characteristics of the metallic glass structures comprises controlling the one or more properties of the electrodeposition process and may include adjusting a rate of formation of the one or more metallic glass structures within the pores of the porous mold. In embodiments, the rate of formation of the one or more metallic glass structures may be adjusted by controlling the one or more properties of the electrodeposition process. For example, the rate of formation may be increased (for some alloys) by increasing the temperature of the plating bath 350, decreasing the temperature of the plating bath 350, applying direct current (DC) to the anode 332, applying alternating current (AC) to the anode 332, increasing the concentration of one or more of the dissolved metal salts of the plating bath 350, decreasing the concentration of one or more of the dissolved metal salts of the plating bath 350, increasing the pressure within the tank 320, decreasing the pressure within the tank 350, other adjustments, or a combination thereof. It is noted that different alloys may be affected differently by changes to the properties of the electrodeposition process. For example, the rate of formation for some alloys may be increased by applying AC current to the anode 332, while the rate of formation for other alloys may be increased by applying DC current to the anode 332.

In embodiments, adjusting the one or more characteristics of the metallic glass structures may include controlling the one or more properties of the electrodeposition process and may include adjusting a composition of the one or more metallic glass structures. For example, portions of the metallic glass structures may be formed of alloys comprising different ratios of two or more metals (e.g., a first portion of a metallic glass structure may comprise a higher percentage of a first metal of an alloy and a second portion of the metallic glass structure may comprise a higher percentage of a second metal of the alloy relative to the first portion), where the different percentages of the alloy metals in different portions of the metallic glass structures are controlled by adjusting the one or more properties of the electrodeposition process. In embodiments, adjusting the properties of the electrodeposition process may include changing aspects of the current applied to the anode 332, changing a concentration of one or more metallic salts in the plating bath 350, changing a temperature of the plating bath 350, changing a pressure within the tank 320, or a combination thereof.

It is noted that different metals and metallic salts may vary with respect to how changes in the properties of the electrodeposition process alter the deposition of metals within the pores of the porous mold, and that the controller 310 may be configured to account for the different behaviors of the metals and metallic salts when controlling the one or more properties of the electrodeposition process. In embodiments, the controller 310 may include a process and a memory storing instructions executable by the processor to implement functionality for controlling the one or more properties of the electrodeposition process. In embodiments, DC current may be provided to the anode 332 during the electrodeposition process, and the current may be approximately 1-10 mA/cm². In embodiments, the temperature of the plating bath 350 may be varied between approximately 35° C. to 50° C., although temperatures greater than or less than this range may be utilized in some applications. In embodiments, the metallic glass structures may be formed as nano-rods, which may have a length of approximately 10-20 μm. In other embodiments, the length of the metallic glass structures may be less than 10 μm or greater than 20 μm.

As described in more detail below, the formation of the catalyst may include dissolving the porous mold 110. For example, in embodiments, following completion of the electrodeposition process, metallic glass structures may be formed in the pores of the porous mold, and the porous mold 110 may then be dissolved by placing the porous mold in a solution of potassium hydroxide (KOH). In embodiments, the porous mold 110 may be disposed on a substrate during the electrodeposition process, and the one or more metallic glass structures may be disposed on a surface of the substrate after the porous mold 110 is dissolved. In some embodiments, the porous mold 110 may be disposed on a substrate during the electrodeposition process, and the porous mold 110 may not be dissolved.

The system 300, as described above, may facilitate fabrication of fully amorphous nanostructured metallic glasses based on palladium (Pd), platinum (Pt), gold (Au) and other noble metals through electrodeposition. Further, the fabrication technique of embodiments utilizing the system 300 facilitates formation of metallic glass structures or coatings with different thickness on the substrate with controlled chemical composition, thereby enabling optimization of catalytic activity of the synthesized metallic glass with scanning electrochemical microscopy (SECM). In embodiments, a scanning kelvin probe (SKP) technique may be utilized to estimate the amorphous system with the highest electro-catalytic activity.

Catalysts formed in accordance with embodiments of the system 300 may exhibit extraordinary electrocatalytic activity, and provide superior performance and durability when compared to traditional techniques for forming catalysts. For example, traditional techniques do not provide for control of the electrochemistry during formation of the catalyst, and therefore, cannot fine-tune the formation of the metallic glass structures to promote certain properties (e.g., mechanical properties, corrosion resistance, oxidation resistance, electrical conductivity and/or resistivity, synthesis of nanostructures having different shapes and thickness, and the like). It is noted that metallic glasses may crystallize when heated to temperatures higher than their crystallization temperature (˜500° C.) which may decrease their catalytic activity.

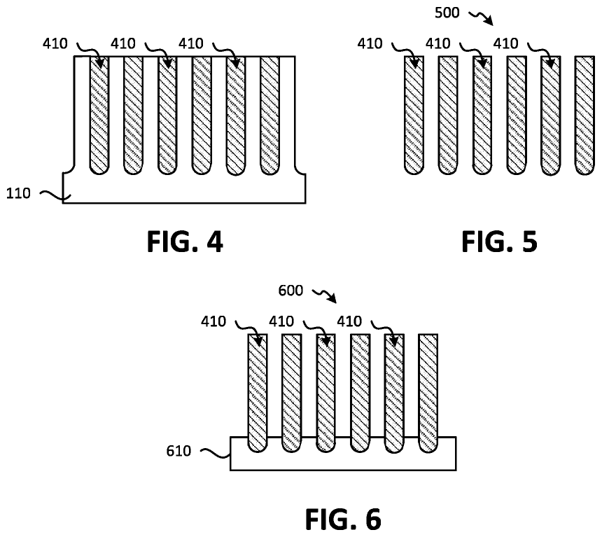

FIG. 4 is a diagram illustrating aspects of forming a catalyst comprising one or more metallic glass structures formed in accordance with embodiments of the present disclosure. As shown in FIG. 4, a plurality of metallic glass structures 410 (e.g., nano-rods) have been formed within the pores 112 of the porous mold 110. FIG. 5 is a diagram illustrating aspects of a catalyst comprising one or more metallic glass structures formed in accordance with embodiments of the present disclosure. As shown in FIG. 5, the porous mold 110 may be dissolved to separate the metallic glass structures 410 from the porous mold 110. FIG. 6 is a diagram illustrating illustrates aspects of a catalyst comprising one or more metallic glass structures formed in accordance with embodiments of the present disclosure. In FIG. 6, the metallic glass structures 410 are shown disposed on a substrate 610. In embodiments, this may be achieved by disposing the porous mold 110 on the substrate 610 during the electrodeposition process described above with reference to FIG. 3, and then dissolving the porous mold 110. As shown in FIG. 6, the metallic glass structures may remain disposed on a surface of the substrate 610 after the porous mold 110 is dissolved.

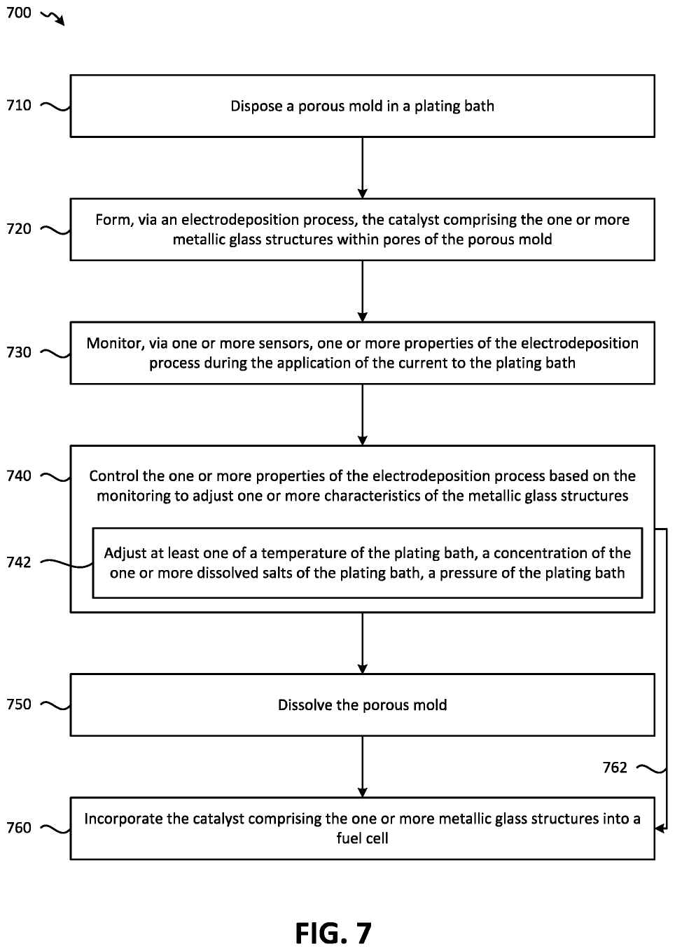

Referring to FIG. 7, a flow diagram illustrating an exemplary method for forming a catalyst comprising one or more metallic glass structures in accordance with embodiments of the present disclosure is shown as a method 700. In embodiments, the method 700 may be implemented using a system, such as the system 300 illustrated and described with reference to FIG. 3 to produce a catalyst (e.g., the catalyst 500 of FIG. 5 and/or the catalyst 600 of FIG. 6). The catalyst may be suitable for use with a fuel cell, an energy storage device, or other energy conversion device.

At 710, the method 700 includes disposing a porous mold in a plating bath. In an embodiment, the porous mold may be the porous mold 110 of FIGS. 1-3. In an embodiment, the plating bath may be the plating bath 350 of FIG. 3, and may comprise a solution including one or more dissolved metal salts. As explained above, the one or more dissolved metal salts may include palladium-based salts (e.g., palladium (II) chloride (PdCl₂), disodium tetrachloropalladate (Na₂PdCl₄)), platinum-based salts, gold-based salts, nickel-based salts (e.g., nickel (II) chloride (NiCl₂)), copper-based salts (e.g., copper (II) chloride (CuCl₂)), other salts (e.g., platinum-based salts and/or gold-based salts), or a combination thereof. At 720, the method 700 includes forming, via an electrodeposition process, the catalyst comprising the one or more metallic glass structures within pores of the porous mold. As explained above with reference to FIG. 3, the electrodeposition process may be initiated by applying a current to an anode disposed in the plating bath, where the porous mold disposed in the plating bath functions as the cathode (or is coupled to a cathode), resulting in deposition of metals associated with the metal salts within the pores of the porous mold.

At 730, the method 700 includes monitoring, via one or more sensors, one or more properties of the electrodeposition process during the application of the current. As explained above, in embodiments, the one or more properties of the electrodeposition process monitored by the one or more sensors may include a temperature of the plating bath, a pressure of the plating bath, a concentration of the one or more dissolved metal salts, a characteristic of the current applied to the anode (e.g., AC or DC current, amount of current, etc.), or a combination thereof. In embodiments, the one or more sensors may include sensors disposed within the plating bath. For example, one or more temperature sensors, pressure sensors, a potentiostat and/or galvanostat, a reference electrode, a saturated calomel (SCE), other sensors, or a combination thereof, may be utilized to monitor the one or more properties of the electrodeposition process, as described above.

At 740, the method 700 includes controlling the one or more properties of the electrodeposition process based on the monitoring to adjust one or more characteristics of the metallic glass structures. As explained above, controlling the one or more properties of the electrodeposition process to adjust the one or more characteristics of the metallic glass structures may include, at 742, adjusting a rate of formation of the one or more metallic glass structures within the pores of the porous mold, adjusting a composition of the one or more metallic glass structures, or both. In embodiments, the one or more metallic glass structures may be formed from an alloy including at least a first metal and a second metal. In embodiments, the first metal may be palladium (Pd), platinum (Pt), gold (Au), other precious metals, or a combination thereof, and the second metal may include copper (Cu), nickel (Ni), another transition metal or metals, or a combination thereof. The controlling/adjusting provides fine-grained tuning of the process of forming the metallic glass structures, which may enable improved performance and/or structural properties of the metallic glass structures.

In embodiments, the method may include, at 750, dissolving the porous mold. In embodiments, the porous mold may be disposed on a substrate, and, the one or more metallic glass structures may be disposed on a surface of the substrate after the porous mold is dissolved. In embodiments, the method 700 may further include, at 760, incorporating the catalyst comprising the one or more metallic glass structures into a fuel cell, an energy storage device, an energy conversion device, or a combination thereof. As indicated by arrow 762, in embodiments, the catalyst may be incorporated into the fuel cell, the energy storage device, the energy conversion device, or a combination thereof without removing the porous mold in some applications of embodiments.

Forming catalysts in accordance with the embodiments described above with reference to FIGS. 1-7 provides several improvements over existing techniques for forming catalysts. For example, existing techniques, such as rapid cooling of a glass forming system from its melting point and thermo-plastic forming process to fabricate nanostructured glass, may be utilized to fabricate metallic glass and nanostructured metallic glasses, however, these processes are time-consuming, less effective and much more expensive relative to the catalyst formation techniques of embodiments. Additionally, when compared to these existing techniques, embodiments provide for the formation of nanostructured metallic glass catalysts at a reduced cost (e.g., by forming the catalyst from alloys, rather than pure precious metals), which may enable further use of fuel cells and other energy storage and conversion technologies in a variety of industries, including the automotive and petroleum refining (e.g., improved catalytic converters), power plants, consumer electronics, battery electrodes, food processing (e.g., hydrogenation of fats). Additionally, embodiments for forming metallic glass coatings may exhibit improved corrosion resistance, providing a technique for providing improved coatings in different industries varying from petroleum to biomedical devices where erosion resistant layers have proved to be a major problem, and provide an economical alternative for forming oxidation resistant protective coatings. For example, metallic glass structures formed in accordance with embodiments are not subject to poisoning, which is a significant problem for catalysts formed from pure precious metals. Thus, embodiments provide numerous advantages and improvements to the field of catalyst formation and oxidation resistant coatings.

Although embodiments of the present application and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Moreover, the scope of the present application is not intended to be limited to the particular embodiments of the process, machine, manufacture, composition of matter, means, methods and steps described in the specification.

1. A method for forming a catalyst comprising one or more metallic glass structures, the method comprising:
disposing a porous mold in a plating bath comprising one or more dissolved metal salts;
forming, via an electrodeposition process, the catalyst comprising the one or more metallic glass structures within pores of the porous mold, the electrodeposition process comprising applying a current to an anode disposed in the plating bath;
monitoring, via one or more sensors, one or more properties of the electrodeposition process during the application of the current; and
controlling the one or more properties of the electrodeposition process based on the monitoring to adjust one or more characteristics of the metallic glass structures.

2. The method of claim 1, wherein the one or more dissolved metal salts comprise palladium-based salts, platinum-based salts, gold-based salts, nickel-based salts, copper-based salts, or a combination thereof.

3. The method of claim 1, wherein the one or more properties of the electrodeposition process comprise a temperature of the plating bath, a pressure within a tank in which the plating bath is disposed, a concentration of the one or more dissolved metal salts, a characteristic of the current applied to the anode, or a combination thereof.

4. The method of claim 3, wherein the controlling the one or more properties of the electrodeposition process to adjust the one or more characteristics of the metallic glass structures comprises adjusting a rate of formation of the one or more metallic glass structures within the pores of the porous mold, adjusting a composition of the one or more metallic glass structures, or both.

5. The method of claim 1, wherein the porous mold comprises a porous anodized aluminum oxide (AAO) nano-mold, and wherein the pores of the porous mold have a width of at least one (1) nanometer (nm).

6. The method of claim 1, wherein the porous mold is disposed on a substrate, the method further comprising dissolving the porous mold, wherein the one or more metallic glass structures are disposed on a surface of the substrate after the porous mold is dissolved.

7. The method of claim 1, wherein the one or more metallic glass structures comprise an alloy including at least a first metal and a second metal, wherein the first metal comprises palladium (Pd), platinum (Pt), gold (Au), or a combination thereof, and wherein the second metal comprises copper (Cu), nickel (Ni), or a combination thereof.

8. The method of claim 1, further comprising incorporating the catalyst comprising the one or more metallic glass structures into a fuel cell.

9. A catalyst comprising one or more metallic glass structures formed by a process comprising:
disposing a porous mold in a plating bath comprising one or more dissolved metal salts;
forming, via an electrodeposition process, the catalyst comprising the one or more metallic glass structures within pores of the porous mold, the electrodeposition process comprising applying a current to an anode disposed in the plating bath;
monitoring, via one or more sensors, one or more properties of the electrodeposition process during the application of the current; and
controlling the one or more properties of the electrodeposition process based on the monitoring to adjust one or more characteristics of the metallic glass structures.

10. The catalyst of claim 9, wherein the one or more dissolved metal salts comprise palladium-based salts, platinum-based salts, gold-based salts, nickel-based salts, copper-based salts, or a combination thereof.

11. The catalyst of claim 9, wherein the one or more properties of the electrodeposition process comprise a temperature of the plating bath, a pressure within a tank in which the plating bath is disposed, a concentration of the one or more dissolved metal salts, a characteristic of the current applied to the anode, or a combination thereof.

12. The catalyst of claim 11, wherein the controlling the one or more properties of the electrodeposition process to adjust the one or more characteristics of the metallic glass structures comprises adjusting a rate of formation of the one or more metallic glass structures within the pores of the porous mold, adjusting a composition of the one or more metallic glass structures, or both.

13. The catalyst of claim 9, wherein the porous mold comprises a porous anodized aluminum oxide (AAO) nano-mold, and wherein the pores of the porous mold have a width of at least one (1) nanometer (nm).

14. The catalyst of claim 9, wherein the porous mold is disposed on a substrate, the method further comprising dissolving the porous mold, wherein the one or more metallic glass structures are disposed on a surface of the substrate after the porous mold is dissolved.

15. The catalyst of claim 9, wherein the one or more metallic glass structures comprise an alloy including at least a first metal and a second metal, wherein the first metal comprises palladium (Pd), platinum (Pt), gold (Au), or a combination thereof, and wherein the second metal comprises copper (Cu), nickel (Ni), or a combination thereof.

16. The catalyst of claim 9, the process further comprising incorporating the catalyst comprising the one or more metallic glass structures into a fuel cell.

17. A system for forming a catalyst comprising one or more metallic glass structures, the system comprising:
a tank;
a plating bath comprising one or more dissolved metal salts, the plating bath disposed in the tank;
a power source configured to apply a current to an anode disposed in the plating bath to form the catalyst comprising the one or more metallic glass structures within pores of a porous mold via an electrodeposition process;
one or more sensors configured to monitor one or more properties of the electrodeposition process during the application of the current to the plating bath; and
a controller configured to control the one or more properties of the electrodeposition process based on the monitoring to adjust one or more characteristics of the metallic glass structures.

18. The system of claim 17, wherein the one or more dissolved metal salts comprise palladium-based salts, platinum-based salts, gold-based salts, nickel-based salts, copper-based salts, or a combination thereof.

19. The catalyst of claim 17, wherein the one or more properties of the electrodeposition process comprise a temperature of the plating bath, a pressure within a tank in which the plating bath is disposed, a concentration of the one or more dissolved metal salts, a characteristic of the current applied to the anode, or a combination thereof, and wherein the controlling the one or more properties of the electrodeposition process to adjust the one or more characteristics of the metallic glass structures comprises adjusting a rate of formation of the one or more metallic glass structures within the pores of the porous mold, adjusting a composition of the one or more metallic glass structures, or both.

20. The system of claim 17, wherein the porous mold comprises a porous anodized aluminum oxide (AAO) nano-mold, and wherein the pores of the porous mold have a width of at least one (1) nanometer (nm).

21. The system of claim 17, wherein the porous mold is disposed on a substrate, the system further comprising a second tank comprising a solvent configured to dissolve the porous mold after completion of the electrodeposition process, wherein the one or more metallic glass structures are disposed on a surface of the substrate after the porous mold is dissolved.

22. The system of claim 17, wherein the one or more metallic glass structures comprise an alloy including at least a first metal and a second metal, wherein the first metal comprises palladium (Pd), platinum (Pt), gold (Au), or a combination thereof, and wherein the second metal comprises copper (Cu), nickel (Ni), or a combination thereof.

23. The system of claim 17, wherein the catalyst comprising the one or more metallic glass structures is incorporated into a fuel cell.
